(19) United States
(12) Patent Application Publication
(10) Pub. No.: US 2006/0042375 A1
(43) Pub. Date: Mar. 2, 2006

(54) Fluid-level sensing and fluid detection

(75) Inventor: Andrew Ceri Davis, Cheltenham (GB)

Correspondence Address: CONNOLLY BOVE LODGE & HUTZ LLP, SUITE 800, 1990 M STREET NW, WASHINGTON, DC, 20036-3425, US

(73) Assignee: Smiths Group plc, London (GB)

(21) Appl. No.: 11/206,081

(22) Filed: Aug. 18, 2005

(30) Foreign Application Priority Data
Aug. 27, 2004 (GB) 0419102.9

(51) Int. Cl. G01F 23/00

(52) U.S. Cl. 73/295

(57) ABSTRACT

An aircraft low fuel level sensing system has a thermistor mounted in a tank at the level at which a warning is to be produced. A constant current source is alternately connected and disconnected from the thermistor so that it cycles between warming and cooling phases. The rate of change of resistance of the thermistor varies with the warming and cooling cycles according to whether it is immersed in fuel or is exposed above the fuel. A processor correlates the thermistor resistance change curves with stored curves to determine whether the curve is indicative of an exposed thermistor, in which case, a low fuel level warning is produced.

### BACKGROUND OF THE INVENTION

This invention relates to apparatus and methods for fluid-level sensing and fluid detection.

There are many applications where it is necessary to sense the level of a fluid, such as a high or low level of fluid. One such application is in aircraft fuel tanks. It is known to use a thermistor or other temperature-sensitive resistance as such a level sensor. The thermistor is supplied with current to cause its temperature to rise above the ambient temperature. When exposed to air or other gas, the temperature of the thermistor will be relatively high. When immersed in fuel, the heat of the sensor is dissipated more rapidly, because of the higher thermal conductivity of the fuel, causing its temperature to drop. The resistance of the thermistor will, therefore, be different depending on whether it is exposed or covered by fuel. By monitoring the resistance, it is possible to determine whether the fuel level is below or above the sensor. One example of such apparatus is described in U.S. Pat. No. 6,644,103.

There are problems with this arrangement, particularly in fuel sensing applications. The sensor must be heated sufficiently to ensure reliable detection even when the liquid is relatively warm, which means that the sensor must be significantly warmer than the liquid. This leads to relatively high currents of 45 mA or more and can lead to the temperature of the sensor approaching the fuel flash point. Also, the current needed to test the sensor can exceed limits set for fuel-wetted components in current aerospace safety regulations.

### BRIEF SUMMARY OF THE INVENTION

It is an object of the present invention to provide alternative fuel-level sensing and fuel detection apparatus and methods.

According to one aspect of the present invention there is provided apparatus for sensing the presence of a fluid including a sensor having a resistance dependent on temperature, means for applying a current to the sensor and means for providing an output dependent on the resistance of the sensor, the means for applying current being arranged to apply current intermittently at different values so that the sensor intermittently warms and cools, and the output means being arranged to monitor the resistance of the sensor as it warms and/or cools thereby to determine whether or not the sensor is immersed in fluid.

One of the different values of current may be zero. The means for applying the current may include a constant current source and the sensor may be a thermistor. The sensor is preferably mounted towards the lower end of a fluid container, the apparatus being arranged to provide an indication of low fluid level in the container when the level of fluid falls below the level of the sensor. The output means is preferably arranged to correlate curves of change of resistance of the sensor between the different values of current with stored curves to determine whether the sensor is immersed in fluid or is exposed above the fluid. The sensor may be mounted with a fuel tank.

According to another aspect of the present invention there is provided a method of sensing the presence of a fluid including the steps of energising a temperature-dependent resistance to produce alternate cycles of warming and cooling and determining whether the cycles are characteristic of a resistance affected or unaffected by the presence of a fluid.

According to a further aspect of the present invention there is provided a method of providing a fluid-level indication including the steps of mounting a temperature-dependent sensor at a level at which the indication is to be provided, energizing the sensor to cause it alternately to warm and cool, monitoring the rate at which the sensor warms and/or cools, and providing an output indication in response to the monitoring when it is indicative of fluid being at that level.

According to a fourth aspect of the present invention there is provided apparatus for use in a method according to the above other or further aspect of the present invention.

Aircraft fuel-level sensing apparatus and its method of operation, according to the present invention, will now be described, by way of example, with reference to the accompanying drawing.

### BRIEF DESCRIPTION OF THE DRAWING

FIG. 1 is a schematic circuit diagram of a first form of the apparatus;

FIG. 2 is a graph illustrating the current cycles supplied to the resistance sensor;

FIG. 3 is a graph illustrating the change in temperature of the sensor as a result of the current cycles;

FIG. 4 is a circuit diagram showing a first modified form of the apparatus;

FIG. 5 is a circuit diagram showing a second modified form of the apparatus; and

FIG. 6 is a circuit diagram showing a third modified form of the apparatus.

### DETAILED DESCRIPTION OF THE PREFERRED EMBODIMENTS

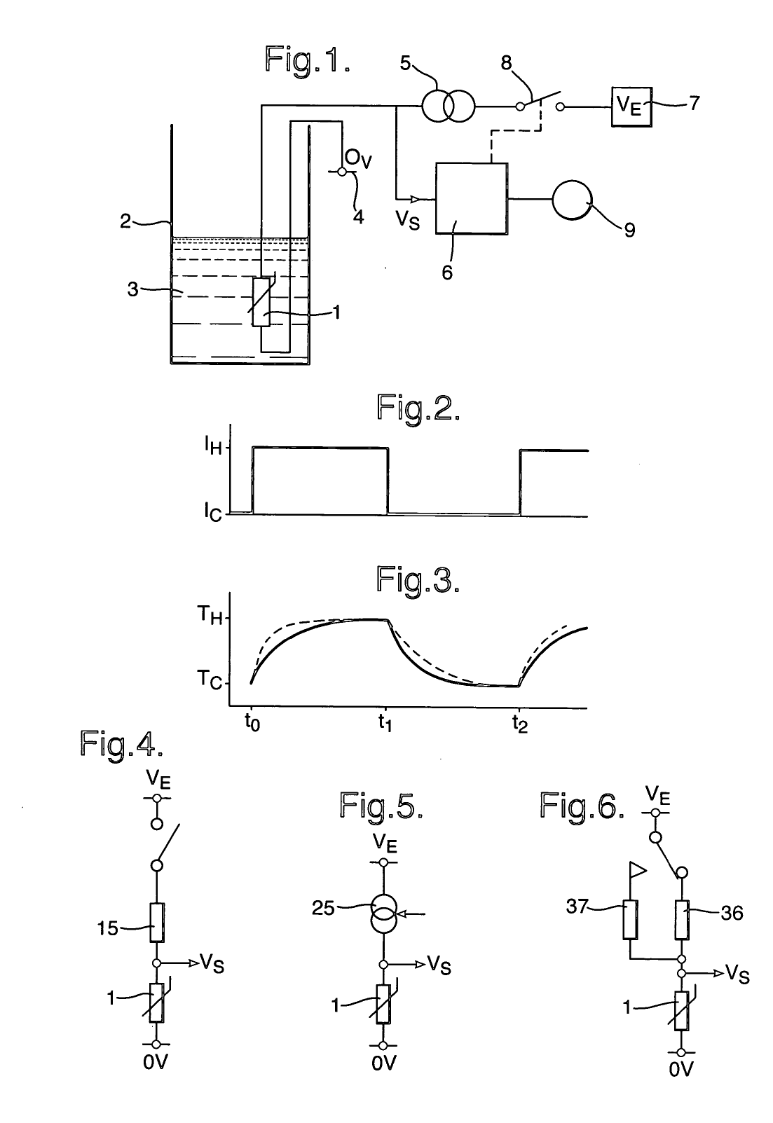

With reference first to FIGS. 1 to 3, the apparatus includes a temperature-dependent resistance sensor 1, such as a thermistor, platinum resistance thermometer or the like, mounted within an aircraft fuel tank 2 at a height at which a signal is to be provided. In the present example, the sensor 1 is mounted towards the bottom of the tank 2 so that the signal is provided when the level of fuel 3 is low. It will be appreciated that the tank 2 would normally also include a conventional gauging probe (not shown) to provide an output according to the quantity of fuel in the tank. One side of the thermistor 1 is connected to a 0 volts rail 4. The other side of the thermistor 1 is connected in parallel to a constant current source 5 and to a processing unit 6. The current source 5 is connected to a voltage source 7 via a switch 8, which is intermittently opened and closed at a regular repetition rate by the processing unit 6. This switching causes the output of the current source 5 to alternate in a square wave fashion, in the manner shown in FIG. 2, from a constant zero level I_{C}=0 (cold) to a higher constant level I_{H} (hot). The processing unit 6 measures the voltage across the thermistor 1 and computes its resistance from the ratio of the current to the voltage. The processor 6 then calculates the temperature T using the sensor's resistance-temperature curve, such as represented in a look-up table. From the temperature, the processor 6 determines whether the sensor 1 is immersed in fuel 3 or is exposed to air. If the sensor 1 is exposed to air, the processing unit 6 provides an output to a display 9 or other utilisation means to provide a warning of low fuel level.

The manner in which the processing unit 6 determines whether or not the thermistor 1 is exposed to air will now be described. The alternating on/off current supplied to the thermistor 1, of the form represented in FIG. 2, causes the thermistor alternately to heat up and cool down in the manner shown by the curve in FIG. 3. While the high level of current I_{H} is applied, over the period t₀ to t₁, the thermistor 1 heats up exponentially from a temperature T_{C} to a temperature T_{H}. When the low/zero level of current I_{C} is applied, between t₁ and t₂, the temperature of the thermistor 1 falls exponentially from T_{H} to T_{C}. The rate of exponential rise and fall of temperature of the thermistor 1, that is, the time constant of the curve, depends on whether it is immersed in fuel or not. When immersed in fuel 3, or other fluid, the heat produced by the thermistor 1 is conducted away more rapidly than when it is exposed to air because of the higher thermal conductivity of the fuel. Thus, when immersed in fuel 3, the rate of rise of temperature during the heating part of the cycle will be less rapid and the rate of fall during the cooling part of the cycle will be more rapid, as shown by the solid line in FIG. 3. When exposed to air, the rate of rise of temperature during the heating part of the cycle will be more rapid and the rate of fall during the cooling part of the cycle will be less rapid, as shown by the broken line in FIG. 3. The resistance of the thermistor 1 varies in a similar fashion but, because of its negative temperature coefficient, the curve of resistance against time is inverted compared with the temperature curve. With other temperature-dependent resistances, having a positive temperature coefficient, the resistance/time curve would be of the same form as the temperature/time curve.

There are various ways in which the processing unit 6 could determine the immersion status of the sensor 1. One way is to correlate the normalised heating or cooling curve against a set of exponential curves stored in a memory and having different time constants. The closest correlating curve represents the nearest time constant. Associated with each curve is a status flag showing whether it is representative of an immersed or exposed condition of the thermistor. This is used to provide the output to the display 9. Alternatively, the immersion status of the sensor 1 could be determined by measuring the change in temperature of the sensor between different parts of the cycle. It is not essential for the temperature of the sensor to be monitored continuously since it could just be determined at a number of test points; a minimum of two points would be required. The immersion status could be determined instead by differentiating the curve at selected points to determine its slope, or by integrating the curve over the cycle or part cycle to determine the area under the curve.

The arrangement according to the present invention enables the presence of fuel to be detected reliably and, because it uses relative temperature rise over a heating and cooling period, during which the heat energy in the sensor dissipates, it can operate at a lower sensor temperature and thus requires a lower test current.

Instead of using a constant current source, a resistor 15 could be used to maintain a nominal current level, in the manner shown in FIG. 4.

In the arrangement of FIG. 5, instead of switching off the current completely between heating cycles, the current source 25 is switched to a low, cooling level, just above zero. Similarly, FIG. 6 shows an arrangement where the current is switched alternately between a high, heating level and a lower (non-zero), cooling level by means of a switch 35 that selects between two different resistors 36 and 37 of different values. This allows the immersion status of the sensor to be determined during the cooling period as well as during the heating period.

It will be appreciated that the present invention is not confined to detecting low or high levels of fluid in a container. For example, a container could have a row of resistance sensors spaced from one another up the height of the container so that an indication of fluid level could be provided by determining which sensors were immersed and which were exposed.

The invention could be used to detect the presence of fluid in other applications, such as in pipelines. The invention is not confined to use with liquid/gas interface levels but could be used anywhere where there are two fluids of different thermal conductivity so that they affect the temperature of the resistance sensor differently. The fluid could be a paste, powder, particulate, granular or other material that is flowable.

What I claim is:

1. Apparatus for sensing the presence of a fluid comprising: a sensor having a resistance dependent on temperature; a source of current; an arrangement for applying the current to said sensor intermittently at different values so that said sensor intermittently warms and cools; and an arrangement for monitoring the resistance of the sensor as it warms and/or cools thereby to determine whether or not said sensor is immersed in fluid.

2. Apparatus according to claim 1, wherein one of the different values of current is zero.

3. Apparatus according to claim 1, wherein said source of current includes a constant current source.

4. Apparatus according to claim 1, wherein said sensor is a thermistor.

5. Apparatus according to claim 1 including a fluid container, wherein said sensor is mounted towards a lower end of said fluid container, and wherein the apparatus is arranged to provide an indication of low fluid level in said container when the level of fluid falls below the level of said sensor.

6. Apparatus according to claim 1, wherein said arrangement for monitoring resistance includes a processor with a store of curves, and wherein the processor is arranged to correlate curves of change of resistance of said sensor between the different values of current with said stored curves to determine whether said sensor is immersed in fluid or is exposed above the fluid.

7. Apparatus according to claim 1 including a fuel tank, and wherein said sensor is mounted in said fuel tank.

8. Apparatus comprising: a fluid tank having a fluid level at which a warning indication is provided; a temperature-dependent resistance mounted at said level; a source of current connected with said resistance and operable repeatedly to vary the current supplied to said resistance between a high level and a low level; and a processor connected to monitor the value of the resistance as it changes when the current is varied to provide an output indication of whether the fluid is above or below said warning level.

9. Apparatus comprising: a fuel tank; a thermistor mounted at a low level within said tank; a source of current arranged intermittently to switch between a high level at which the thermistor is warmed and a low level at which the thermistor cools; and a processor connected with said thermistor to monitor the cycles of changes of resistance produced by warming and cooling of said thermistor and to produce an output indication when the cycles are indicative that the thermistor is exposed above the fuel.

10. A method of sensing the presence of a fluid comprising the steps of energizing a temperature-dependent resistance to produce alternate cycles of warming and cooling, and determining whether said cycles are characteristic of a resistance affected or unaffected by the presence of a fluid.

11. A method of providing a fluid-level indication comprising the steps of: mounting a temperature-dependent sensor at a level at which the indication is to be provided; energizing said sensor to cause it alternately to warm and cool; monitoring the rate at which said sensor warms and/or cools; and providing an output indication in response to said monitoring when it is indicative of fluid being at said level.

12. A method of sensing the presence of fluid, comprising the steps of: exposing a temperature-dependent sensor to fluid; supplying current alternately at a high level and a lower level to said sensor so that it warms and cools; monitoring the resistance of said sensor as it changes with change in current; and indicating when the change of resistance is indicative of a change in whether the sensor is contacted by fluid and is not contacted by fluid.
